(19) United States
(12) Patent Application Publication
(10) Pub. No.: US 2026/0355062 A1
(43) Pub. Date: Nov. 12, 2026

(54) Home And Travel Baby Feeding System

(71) Applicant: Ayva, LLC, Peoria, AZ (US)

(72) Inventor: James W. Holley, JR., Peoria, AZ (US)

(73) Assignee: Ayva, LLC, Peoria, AZ (US)

(21) Appl. No.: 19/201,812

(22) Filed: May 7, 2025

(51) Int. Cl. A61J 9/00; A61J 11/00

(52) U.S. Cl. CPC A61J 9/008; A61J 11/006

(57) ABSTRACT

A baby feeding system includes a single-chamber bottle structure and a multi-chamber bottle structure that have substantially identical upper necks and lower flanges to provide both home-type and travel-type bottle assemblies that utilize the same nipple assembly and the same bottom vent assembly. During set-up, formula and water are inserted into the multi-chamber bottle structure through separate openings and then sealed inside separate powder and water chambers by connecting the nipple assembly and bottom vent assembly. The multi-chamber bottle structure includes a mixing control mechanism that closes to isolate formula and water during set-up and travel (non-feeding) periods and opens to facilitate milk production (formula/water intermixing) immediately before consumption. To prevent nipple confusion, the nipple assembly provides both home-type and travel-type bottle assemblies with the same mouth feel, and the bottom vent assembly includes an anti-colic venting device that provides both bottle assemblies with the same drinking performance.

### FIELD OF THE INVENTION

The present invention relates to baby bottles, and more specifically it relates to baby bottles in which powdered baby formula is mixed with water to produce milk.

### RELATED ART

Powdered baby formula is a manufactured food that is dissolved in (mixed with) mixed with water to produce infant consumable liquid formula milk, which is referred to as “milk” herein for brevity. When kept dry, powdered baby formula may be stored for extended periods without refrigeration. However, once the powdered formula is dissolved in water to produce milk, the milk must either be refrigerated or consumed within a short period of time (i.e., to prevent spoilage due to bacterial growth that occurs when milk is maintained at room temperatures).

Powdered baby formula is typically prepared (mixed with water) and consumed using a baby bottle (aka, nursing bottle or feeding bottle). Baby bottles may be generally categorized into two groups: standard single-chamber baby bottles and multi-chambered (travel-type) baby bottles.

Standard baby bottles typically include a plastic bottle structure having a threaded neck surrounding an upper opening through which predetermined amounts of powdered formula and water may be inserted into the bottle structure's inner chamber. A soft nipple (teat) is then attached to the threaded neck, typically by way of a corresponding threaded collar, such that the nipple closes the upper opening, thereby sealing the water and formula inside the bottle. The enclosed bottle is then shaken to form milk by intermixing the formula and water in the chamber, and then the milk is suckled out of the bottle by an infant through a small opening formed in the nipple. Standard baby bottles are preferrable for at-home use because the availability of suitable measuring devices and substantially sterile surroundings facilitates sanitary set-up (i.e., inserting formula and water and attaching the nipple), and because their simple single-chamber configuration makes standard baby bottles relatively easy to clean/sterilize after each use.

Multi-chamber baby bottles typically include a more complex bottle structure (i.e., in comparison to standard baby bottles) that provides a powder chamber into which powdered baby formula may be stored, a water chamber into which water may be stored, and a mixing control mechanism that maintains the bottle assembly in either a closed/travel configuration in which the formula is kept separate from the water, or an open/feeding configuration in which the formula and water are allowed to intermix. Multi-chamber baby bottles are used for feeding infants when away from home (i.e., where suitable measuring devices and/or reliably sterile surroundings may be unavailable) and are therefore often referred to as travel or travel-type baby bottles. The advantages of multi-chamber baby bottles are that they can be primed (set-up for later use) at home using suitable measuring devices and in substantially sterile surroundings and facilitate the water/formula mixing process immediately before consumption without exposing either the water or the formula to potentially non-sterile environments. That is, between the priming and mixing/feeding operations, multi-chamber baby bottles maintain the powdered baby formula in separate chambers that are protected from potentially non-sterile environments by the bottle's peripheral wall(s). In addition, the mixing control mechanisms of at least some multi-chamber baby bottles facilitate conducting the water/formula mixing process entirely within the bottle structure (i.e., without exposing either the water or the formula to potentially non-sterile environments), whereby the powdered baby formula remains dry and sterile until immediately before being converted to milk and consumed by an infant. A disadvantage of travel-type baby bottles is that their complex bottle structures cause more time-consuming priming and cleaning processes (i.e., in comparison to standard baby bottles), which is why parents typically choose to feed their infants using standard baby bottles when at home and to use multi-chamber bottles only when feeding operations are performed away from home.

Many currently available baby bottles include anti-colic venting mechanisms that serve to regulate air pressure in the bottle's milk chamber during feeding. Before the development of such venting devices, the only passage into or out of baby bottles was through the small nipple opening (feeding duct). As an infant suckles milk through the nipple opening, the decrease in liquid volume in the baby bottle created a gradual increase in vacuum (i.e., a gradual decrease in pressure inside the bottle). This gradually increasing vacuum impeded the flow of liquid out the nipple and forced the baby to suck harder to draw milk through the nipple opening. As the infant sucked harder, air inadvertently entered the infant's mouth and stomach and caused colic (i.e., excessive air in the stomach and other parts of the digestive system is believed to be a cause of colic, which is a condition characterized by prolonged inconsolable crying). The anti-colic venting mechanisms now used on many bottles are believed to reduce colic-related symptoms by regulating the pressure inside the bottle (i.e., by allowing air to enter the bottle without interrupting the suckling process). Early anti-colic venting mechanisms included a slit-like vent hole formed in the flange surrounding a baby bottle nipple, which is secured to a threaded neck of the baby bottle by way of an annular cap. This vent hole is biased into a closed position when the bottle is not in use and opens to allow the inflow of air in response to the lower pressure generated inside the bottle caused by a feeding infant. A problem with this type of conventional venting mechanism is that the air entering the baby bottle passes through the remaining milk or formula, causing the generation of bubbles that may be subsequently consumed by the infant. More recently developed anti-colic venting mechanisms include vent tubes (venting straws) that extend from the nipple to point near the bottom of a standard baby bottle and are configured such that air entering the bottle during feeding avoids the generation of milk (i.e., because the distal end of the vent tube is positioned near or above the milk's surface when the bottle is inverted during feeding).

A problem associated with feeding infants using both home-type and travel-type baby bottles is that they require different nipple assemblies and utilize different venting mechanisms, whereby the mouth feel and drinking performance (i.e., the shape and feel of the nipple and the amount of suckling pressure needed to draw milk through the nipple) of travel baby bottles is often significantly different from standard baby bottles. Babies typically become accustomed to the mouth feel and drinking performance of a particular (e. g., home-type) bottle assembly and may become distressed when presented with a different (e. g., travel-type) bottle assembly having a different nipple and/or anti-colic venting mechanism. This distress, often referred to as nipple confusion, can turn into nipple refusal in which the infant refuses both the home-type and travel-type bottle assemblies, which in turn can lead to health issues associated with sub-optimal nutrition. One reason for the use of different home/travel nipples and venting mechanisms is that the venting mechanisms often used by standard baby bottles include elongated tubes/straws that extend the entire length of the bottle's single milk chamber, and therefore cannot be easily implemented in multi-chamber travel-type bottles (e. g., because the mixing control mechanism would prevent the tube/straw from extending through all chambers of the multi-chamber bottle structure when in the closed/travel position).

Another problem associated with some conventional travel-type baby bottles is bacterial growth caused by inadvertent contact between formula and water during the priming process. That is, some multi-chamber bottle structures are configured such that, when water is inserted into the water chamber during a priming process, significant residual moisture may be inadvertently retained on bottle surfaces that are shared with (or are otherwise exposed to) the bottle's powder chamber. If a portion of the formula comes into contact with this retained/residual moisture during the period between the priming process and a feeding process, the moistened formula portion may become activated. If maintained at a relatively warm temperature and a significant amount of time passes between the priming process and a subsequent infant feeding process, the activated moistened formula may produce a sufficient amount of bacterial growth that, if ingested by the infant during the feeding process, could cause serious health problems.

What is needed is a baby feeding system that provides both the simplicity of single-chamber home-type bottles and the convenience and safety of multi-chamber travel-type bottles while avoiding nipple confusion. What is also needed is a multi-chamber (travel-type) bottle assembly and associated priming method that avoids the bacterial growth problem associated with some conventional multi-chambered baby bottles.

### SUMMARY

In an embodiment the present invention is directed to a baby feeding system including a single-chamber bottle structure and a multi-chamber bottle structure that are configured to utilize the same nipple assembly and the same bottom vent assembly (i.e., a bottom cap including an anti-colic venting device). Both the single-chamber bottle structure and the multi-chamber bottle structure include substantially identical neck structures that are configured to mate with a collar of the nipple assembly (e.g., such that the nipple assembly can be screwed onto or otherwise operably connected to the neck structure of either the single-chamber bottle structure or the multi-chamber bottle structure). Similarly, the lower ends of both bottle structures include substantially identical neck-like lower flanges that are configured to mate with the bottom cap of the bottom vent assembly (e.g., such that the bottom vent assembly can be screwed onto or otherwise operably connected to the lower end of either bottle structure). A relatively easy-to-use and easy-to-clean home-type bottle assembly is formed when the nipple assembly and the bottom vent assembly are mounted on the single-chamber bottle structure (i. e., whereby water and formula may be mixed in the bottle's single chamber immediately before feeding). A travel-type bottle assembly is formed when water and formula are stored in separate powder and water chambers of the multi-chamber bottle structure that are enclosed by way of attaching the nipple assembly and the bottom vent assembly, thereby facilitating safe and sanitary feeding when away from home. By facilitating the use of the same (or two substantially identical) nipple and bottom vent assemblies on both single-chamber and multi-chamber bottle structures, the baby feeding system avoids nipple confusion by providing both a home-type bottle assembly and travel-type bottle assembly that exhibit substantially identical mouth feels and drinking performances. That is, by configuring both bottle structures to utilize the same nipple assembly (or two substantially identical nipple assemblies), an infant experiences the same nipple shape and feel when feeding from either the home-type bottle assembly or the travel-type bottle assembly. Moreover, by configuring both bottle structures to utilize the same bottom vent assembly (or two substantially identical bottom vent assemblies), an infant experiences the same amount of suckling pressure when feeding from either bottle assembly.

The nipple assembly and bottom vent assembly utilized by the baby feeding system may be implemented using either conventional or modified structures, provided the implemented structures are alternately operably connectable to both the single-chamber bottle structure and the multi-chamber bottle structure. In alternative exemplary embodiments the nipple assembly includes either a one-piece structure or a two-piece structure in which a cylindrical collar is sized and configured for operably attachment to the necks of both bottle structures by way of a threaded connection. In other embodiments the nipple assembly may utilize a collar having a non-cylindrical configuration and may connect to correspondingly configured necks on both bottle structures by way of other (e.g., snap-couple-type) fastening mechanisms. Similarly, the bottom assemblies of the exemplary embodiments include bottom caps that are implemented using a collar-like cylindrical wall structure sized and configured to attach by way of threaded connection to the lower flanges of both bottle structures but may be implemented using other configurations and/or fastening mechanisms. In some exemplary embodiments the bottom cap includes a disk-like cover plate that defines one or more vent openings, and the anti-colic vent device is implemented by elastomeric (e.g., silicone) membrane structure located on (i.e., abutting) an inside surface of the cover plate and maintained in a trampoline-like arrangement (i.e., with a peripheral edge pinched between the bottom cap and the cover plate). As milk is drawn out of a bottle assembly by a suckling infant, the resulting low pressure inside the bottle structure causes the elastomeric membrane structure to bow inward (away from the cover plate), thereby opening a one-way pressure-regulating feature (e.g., one or more flap-type or pinhole-type vent devices disposed on a central portion of the elastomeric membrane structure) to admit air drawn through the vent opening into the bottle structure. In other embodiments the anti-colic vent device may be implemented by another one-way pressure-regulating feature that is operably connected to the bottom cap.

Both the single-chamber bottle structure and multi-chamber bottle structure may be implemented using a variety of configurations, provided the necks of the two bottle structures are substantially identical, and provided both bottle structures include lower openings surrounded by substantially identical lower flanges. In some embodiments the multi-chamber bottle structure includes a powder chamber that is accessed by way of an upper opening surrounding by a neck, a water chamber that is accessed by way of a lower opening surrounding by a lower flange, and a mixing control mechanism that facilitates manual adjustment between a closed (travel) configuration and an open (feeding) configuration. When the mixing control mechanism is set such that the multi-chamber bottle structure is in the closed configuration, an intervening wall (watertight barrier) is positioned between the powder chamber and the water chamber, thereby blocking/preventing moisture from seeping or leaking from the water chamber into the powder chamber and prematurely activating the formula. When subsequently manually adjusted from the travel configuration to the feeding configuration, the mixing control mechanism repositions/removes the wall/barrier or otherwise provides a flow passage between the powder chamber and the water chamber, thereby allowing the water and formula to freely intermix to form milk that can then be consumed through the nipple assembly. Providing the multi-chamber bottle structure with powder and water chambers that can be accessed by two separate openings facilitates a novel priming (formula and water insertion and sealing) process in which the multi-chamber bottle structure is assembled and configured such that the mixing control mechanism is set in the closed (travel) configuration, then the formula and water are inserted directly into corresponding powder/water chambers through the two separate (i.e., upper and lower) openings, then the formula and water are sealed inside the powder/water chambers by way of attaching the nipple assembly and the bottom vent assembly. By inserting the water directly into the water chamber through the lower flange (lower opening) while maintaining the mixing control mechanism in the closed (travel) configuration, the priming process avoids the residual moisture problem associated with some conventional travel-type baby bottles (i.e., because the water does not contact any surfaces shared with the powder chamber during insertion). Moreover, the bacterial growth problem may be entirely avoided by maintaining the mixing control mechanism in the closed (travel) configuration from the beginning of the insertion process until a desired feeding operation (i.e., when the mixing control mechanism is purposefully manually reconfigured by a parent from the closed/travel configuration to the open/feeding configuration).

In accordance with a specific embodiment, the multi-chamber bottle structure is implemented by a ball-valve-type (ball-type) bottle assembly including a hollow ball member, a container body (body), a housing and an O-ring. The hollow ball member includes a spherical (curved) peripheral wall that surrounds a powder chamber, a neck that extends from an upper end of the spherical peripheral wall, and a lower opening formed at a lower end of the peripheral wall. The body includes a substantially cylindrical peripheral wall surrounding a water chamber and includes both a lower flange which is configured to engage with the bottom vent assembly, and an upper flange including exterior helical threads, an annular O-ring groove and a bowl-like flange portion that surround an upper opening, where the O-ring groove functions to receive the O-ring and the bowl-like flange portion serves as a ball socket that receives the hollow ball member. The housing includes a cylindrical peripheral wall having a dome-like upper shoulder that defines an actuating slot (slot-like opening) and includes helical threads that mate with the exterior helical threads formed on the container body. The housing is configured to receive the ball member such that the neck extends through slot-like upper opening and the spherical peripheral wall is maintained over the bowl-like flange portion when the housing is screw-connected to the container body, whereby tightening the housing involves turning the housing in a first (e. g., clockwise) direction relative to the container body and loosening the housing involves turning the housing in the opposite (e.g., counterclockwise) direction. When the housing is tightened, the shoulder pushes the hollow ball member against the bowl-like flange portion and the O-ring with sufficient force to prevent rotation/pivoting of the hollow ball member, and when the housing is loosened, the hollow ball member is free to rotate/pivot within the bowl-like flange portion. In this embodiment the peripheral wall of the multi-chamber bottle structure is implemented by the spherical peripheral wall of the hollow ball member (which surrounds the powder chamber), the substantially cylindrical peripheral wall of the container body (which surrounds the water chamber) and may include a portion of the peripheral wall of the housing. The neck of the multi-chamber bottle structure is implemented by the neck of the hollow ball member, and the lower flange of the multi-chamber bottle structure is implemented by the lower flange of the container body. In addition, the mixing control mechanism of the ball-type bottle assembly is implemented by the housing and the hollow ball member, whereby manually loosening the housing facilitates rotating/pivoting the hollow ball member between a closed (travel) configuration, wherein formula stored in the powder chamber is separated from water stored in the water chamber by a portion of the spherical peripheral wall, and an open (feeding) configuration, wherein the lower opening of the hollow ball member aligns with the upper opening of the container body, whereby the powder chamber communicates with the water chamber by way of a flow passage, which is formed by alignment of the upper/lower openings, such that the water and formula intermix to form milk.

According to another embodiment, a method for priming (setting-up or preparing) ) a travel-type bottle assembly for use includes assembling or otherwise configuring a multi-chambered bottle structure such that its powder chamber is isolated from its water chamber, and then inserting formulate through a first opening (e.g., through the bottle's neck) into the powder chamber and securing the cap assembly to the neck and inserting water through the bottle's lower flange into the water chamber and securing the bottom cap (or bottom vent assembly). This method is preferably implemented using a multi-chambered bottle structure having powder and water chambers that can be respectively accessed by two separate (e.g., upper and lower) openings while the mixing control mechanism is set in the closed (travel) configuration. By assembling or otherwise configuring the multi-chamber bottle structure such that the mixing control mechanism is in the travel/closed configuration before inserting formula and water through the two separate (e.g., upper and lower) openings and completing the travel-type bottle assembly by operably connecting the nipple assembly and the bottom cap, the priming method avoids the bacterial growth problem associated with some travel-type bottle assemblies.

The present invention will be more fully understood in view of the following description and drawings.

### BRIEF DESCRIPTION OF THE DRAWINGS

FIG. 1 is a cross-sectional side view showing a baby feeding system according to a generalized exemplary embodiment of the present invention;

FIGS. 2A and 2B are cross-sectional side views respectively depicting a home-type bottle assembly and a travel-type bottle assembly of the baby feeding system of FIG. 1 during use;

FIG. 3 shows components of a baby feeding system in cross-sectional side view according to a first specific embodiment of the present invention;

FIGS. 4A and 4B are cross-sectional side views showing the nipple assembly of the baby feeding system of FIG. 3;

FIGS. 5A and 5B are cross-sectional side views showing the bottom venting assembly of the baby feeding system of FIG. 3;

FIGS. 6A and 6B are enlarged partial cross-sectional side view showing a vent device of the bottom venting assembly of FIG. 5B during operation;

FIGS. 7A, 7B, 7C and 7D are cross-sectional side views showing an exemplary method for assembling the multi-chamber bottle structure utilized by the baby feeding system of FIG. 3;

FIGS. 8A and 8B are cross-sectional side views showing the multi-chamber bottle structure of FIG. 7D during a formula charging operation;

FIGS. 9A and 9B are cross-sectional side views showing a travel-type bottle assembly after completing a water charging operation on the multi-chamber bottle structure of FIG. 8B;

FIGS. 10A, 10B, 10C, 10D, 10E and 10F are cross-sectional side views showing the travel-type bottle assembly of FIG. 9B during a formula/water mixing operation and subsequent feeding process;

FIGS. 11A and 11B are cross-sectional side views showing a bottom venting assembly according to another specific embodiment; and

FIGS. 12A and 12B are partial cross-sectional side views showing the bottom venting assembly of FIG. 11 during operation.

### DETAILED DESCRIPTION

The present invention is described below with specific reference to a baby bottle assembly, which represents one type of beverage container that benefits from the present invention. As used herein, directional terms such as “upper”, “upwards”, “lower”, “downward”, “front”, “rear”, “top” and “bottom” are intended to provide relative positions for purposes of description and are not intended to designate an absolute frame of reference. In addition, the phrases “integrally connected” and “integrally molded” is used herein to describe the connective relationship between two portions of a single molded or machined structure and are distinguished from the terms “connected” or “coupled” (without the modifier “integrally”), which indicates two separate structures that are joined by way of, for example, threaded connection, adhesive, fastener, clip, or movable joint. Various modifications to the preferred embodiment will be apparent to those with skill in the art, and the general principles defined herein may be applied to other embodiments. Therefore, the present invention is not intended to be limited to the particular embodiments shown and described but should be accorded with the widest scope consistent with the principles and novel features herein disclosed.

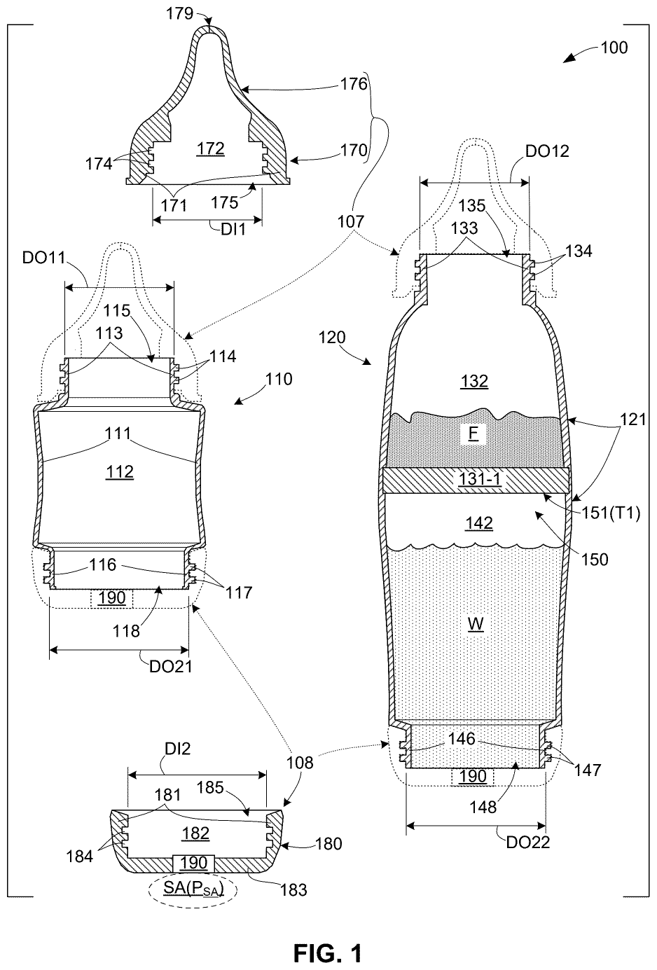

FIG. 1 shows a baby feeding system 100 including a single-chamber (home-type) bottle structure 110, a multi-chamber (travel-type) bottle structure 120, a nipple assembly 107 and a bottom vent assembly 108. As described in additional detail below, both single-chamber bottle structure 110 and multi-chamber bottle structure 120 are configured to utilize nipple assembly 107 and bottom vent assembly 108. For descriptive purposes, the phrase “home-type bottle assembly” refers to a combination formed by operably connecting nipple assembly 107 and bottom vent assembly 108 to single-chamber bottle structure 110, and the phrase “travel-type bottle assembly” refers to a combination formed by operably connecting nipple assembly 107 and bottom vent assembly 108 to multi-chamber bottle structure 120. Note that the descriptors “home-type” and “travel-type” are used herein to clearly distinguish the two different bottle combinations based on their anticipated primary applications, and these terms are not intended to specify any restrictions regarding their use (e.g., the home-type bottle assembly may be utilized outside of home, and the travel-type bottle assembly may be utilized at home). The figures depict the various components of baby feeding system 100 (as well as the components of other embodiments) in cross-sectional view in a form that is simplified for descriptive purposes, and the relative sizes and shapes of the components depicted in the figures are not intended to represent a fixed scale and/or actual structural configuration.

Single-chamber bottle structure 110 includes a peripheral wall 111 that surrounds a (first) chamber 112, a (first) neck 113 that extends from an upper end of peripheral wall 111 and surrounds a (first) upper opening 115, and a (first) lower flange 116 that extends from a lower end of peripheral wall 111 and surrounds a (first) lower opening 118. Upper opening 115 and lower opening 118 communicate with chamber 112 (i.e., formula, water or milk may be inserted into chamber 112 through either opening 115 or 118). Neck 113 and lower flange 116 are respectively sized and configured to operably connect to nipple assembly 107 and bottom vent assembly 108, respectively, whereby chamber 112 is substantially enclosed (i.e., air and/or milk flow through openings 115 and 118 is restricted as described below). In the depicted embodiment peripheral wall 111, neck 113 and lower flange 116 are implemented as cylindrical or substantially cylindrical structures, where neck 113 has an outer diameter DO11 and includes external helical threads 114 that are configured to mate with a threaded collar 170 of nipple assembly 107, and lower flange 116 has an outer diameter DO21 and includes external helical threads 117 that are configured to mate with a bottom cap 180 of bottom vent assembly 108. In other embodiments (not shown), the peripheral wall, neck and/or lower flange of bottle 110 may have one or more other configurations (e.g., have a square or other non-cylindrical shape and/or utilize a snap-together or other fastening mechanism in place of threads), provided nipple assembly 107 and/or bottom vent assembly 108 have corresponding configurations that facilitate operable (e.g., secure, leak-free) connection to the neck and lower flange, respectively. In one embodiment bottle structure 110 may be an integrally molded plastic structure formed in accordance with known plastic molding techniques.

Multi-chamber bottle structure 120 includes at least one (second) peripheral wall 121 surrounding a powder (second) chamber 132 and a water (third) chamber 142, a (second) neck 133 located at an upper end of peripheral wall 121 and surrounding a second upper opening 135 and a second lower flange 146 integrally connected to and located at a lower end of peripheral wall 121 and surrounding a (second) lower opening 148. Upper opening 135 communicates with powder chamber 132 and lower opening 148 communicates with water chamber 142. Neck 133 has a size and configuration that is substantially identical to neck 113 of single-chamber bottle structure 110 such that nipple assembly 107 is alternately operably connectable to either neck 113 or neck 133. Similarly, lower flange 146 has a size and configuration that is substantially identical to lower flange 116 of single-chamber bottle structure 110 such that bottom vent assembly 108 is alternately operably connectable to either lower flange 116 or lower flange 146. In the depicted embodiment peripheral wall 121, neck 133 and lower flange 146 are implemented as cylindrical or substantially cylindrical structures, where neck 133 has an outer diameter DO21 and includes external helical threads 134 that are configured to mate with collar 170 of nipple assembly 107, and lower flange 146 has an outer diameter DO22 and includes external helical threads 147 that are configured to mate with bottom cap 180 of bottom vent assembly 108.

Multi-chamber bottle structure 120 also includes a mixing control mechanism 150 that is configured to facilitate manual adjustment of bottle structure 120 between a travel (closed) configuration and a feeding (open) configuration.

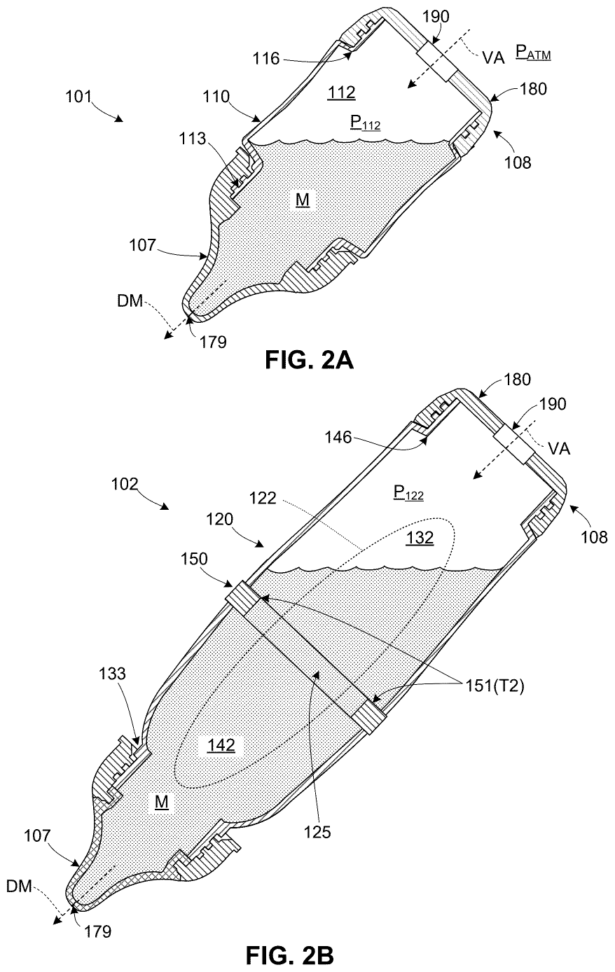

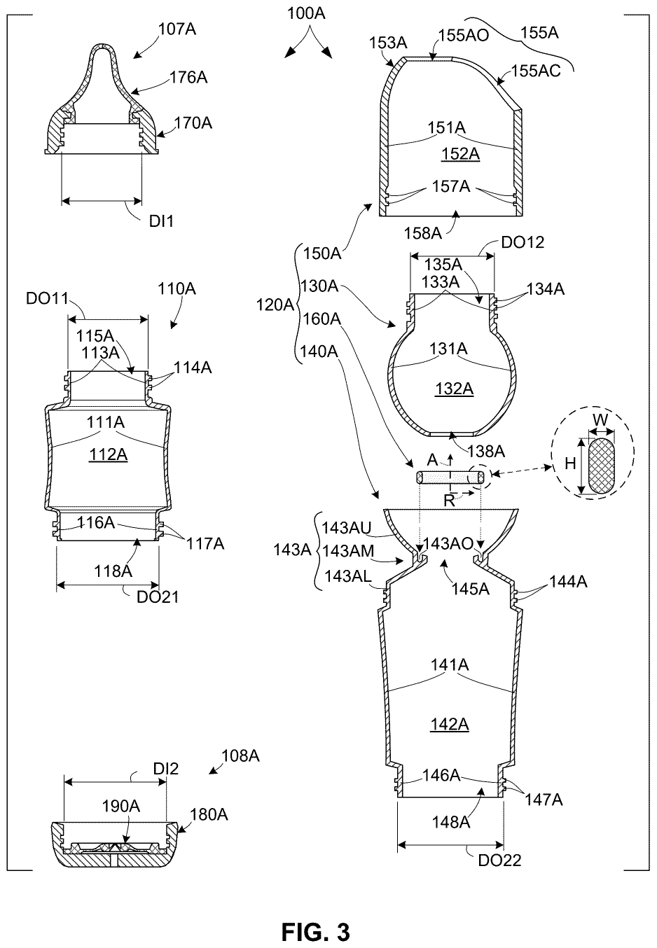

FIG. 1 depicts mixing control mechanism 150 at a time T1 when mixing control mechanism 150 (T1) is in the travel configuration, and FIG. 2B depicts mixing control mechanism 150 at a time T2 when mixing control mechanism 150(T2) is in the feeding configuration. In one embodiment, mixing control mechanism 150 utilizes a control structure 151 that provides a wall 131-1 between formula F stored in the powder chamber 132 and water W stored in water chamber 142 when bottle structure 120 is in the travel/closed configuration (shown in FIG. 1), and provides a flow passage 125 (i.e., an opening formed by displacing or removing the wall/barrier) when bottle structure 120 is in the feeding/open configuration (shown in FIG. 2A). Referring to FIG. 1, when mixing control mechanism 150 is in the travel/closed configuration, control structure 151 (T1)) provides a wall 131-1 that forms at least part of a watertight barrier between powder chamber 132 and water chamber 142. That is, wall 131-1 and the adjacent bottle structure are collectively configured to prevent moisture from leaking or otherwise migrating from water chamber 142 to powder chamber 132), whereby formula F is maintained in a dry (inactive) state while mixing control mechanism 150 is maintained in the travel/closed configuration (e.g., as shown in FIG. 1). Referring to FIG. 2B, when control structure 151 (T2) is subsequently selectively actuated by a parent/user (e.g., by way of a push-button or other manual control mechanism, not shown) to reconfigure mixing control mechanism 150 from the travel/closed configuration to the feeding/open configuration, the watertight barrier is removed and control structure 151 (T2) provides flow passage 125 between powder chamber 132 and water chamber 142, whereby the water and formula are able to freely intermix to form milk M inside combined chamber 122 of travel-type bottle assembly 102. Mixing control mechanism 150 is depicted in FIG. 1 in a generalized manner to reflect the various specific mechanisms that may be employed to perform the function of mixing control mechanism 150. For example, mixing control mechanism 150 may be implemented using a door-type mechanism that may be closed prior to storage of formula in powder chamber 132 and water in water chamber 142, and then actuated (opened) by way of a push button or other manual release mechanism such that the formula and water may be mixed to form milk. In a presently preferred embodiment, the mixing control mechanism is implemented as part of the ball-type two-chambered bottle structure described below with reference to FIG. 3. Note that aspects of the present invention that are independent of the mixing control mechanism are considered novel and non-obvious, and that the specific mixing control mechanisms described herein are not intended to limit the appended claims unless specified.

Nipple assembly 107 includes a collar 170 and a teat 176 that collectively surround a tapered flow passage 172 extending from a relatively wide opening 175 to a small feeding duct 179 formed at an upper end of teat 176. In one embodiment, collar 170 includes a cylindrical wall 171 that surrounds a lower portion of flow passage 172 and has an inside diameter DI1 and interior helical threads 174 that are configured to mate with the exterior helical threads formed on either neck 113 or neck 133 (e.g., inside diameter DI1 is slightly larger than outside diameters DO11 and DO12 and threads 174 are configured to mate with threads 114 and 134, thereby facilitating the secure connection/insertion of neck 113 or neck 133 into collar 170). Teat 176 includes a dome-shaped wall that extends upward from collar 170 and surrounds an upper portion of flow passage 172. Using the example set forth above (i.e., necks 113 and 133 are implemented by cylindrical structures having helical external threads 114 and 134, respectively), collar 170 is alternately operably connectable by way of interior helical threads 174 to neck 113 of bottle structure 110 or neck 133 of bottle structure 120. Specifically, collar 170 is configured such that when it is operably connected to (i.e., mounted over and screwed onto) neck 113, nipple assembly 107 communicates with upper opening 115 to facilitate feeding from single-chamber bottle structure 110, and when it is operably connected to neck 133, nipple assembly 107 communicates with upper opening 135 to facilitate feeding from multi-chamber bottle structure 120.

Bottom vent assembly 108 includes a bottom cap 180 and an anti-colic vent device 190. Bottom cap 180 includes a collar-like cylindrical wall structure 181 that surrounds an inner cap region 182 and a cover plate 183 that substantially encloses a lower end of inner cap region 182.

Wall structure 181 has an inner diameter DI2 that is slightly larger than outer diameters DO21 and DO22 and includes interior helical threads 174 that are configured to mate with exterior threads 114 and 134. Bottom cap 180 is alternately operably connectable to both single-chambered bottle structure 110 (e.g., by way of inserting and twisting lower flange 116 into an upper opening 185 of bottom cap 180) and multi-chambered bottle structure 120 (i.e., by way of inserting and twisting lower flange 146 into upper opening 185). Cover plate 183 is connected to a lower end of wall structure 181 and forms a barrier that substantially encloses a lower end of inter cap region 182. Anti-colic vent device 190 is operably connected to bottom cap 180 and is configured to allow air to vent into (i.e., pass through bottom cap 180 and to enter) either chamber 112 (i.e., when bottom vent assembly 108 is attached to single-chamber bottle structure 110, as indicated in FIG. 2A) or combined chamber 122 (i.e., when bottom vent assembly 108 is attached to multi-chamber bottle structure 120, as indicated in FIG. 2B).

FIGS. 2A and 2B illustrate a home-type bottle assembly 101 and a travel-type bottle assembly 102 that may be formed using the components of baby feeding system 100 (shown in FIG. 1). In particular, home-type bottle assembly 101 (FIG. 2A) includes single-chamber bottle structure 110, nipple assembly 107 and bottom vent assembly 108, and travel-type bottle assembly 102 (FIG. 2B) includes multi-chamber bottle structure 120, nipple assembly 107 and bottom vent assembly 108. Note that home-type bottle assembly 101 and travel-type bottle assembly 102 are depicted during corresponding feeding processes: that is FIG. 2A depicts home-type bottle assembly 101 in an inverted orientation that facilitates suckling of milk by an infant (not shown) from single-chamber bottle structure 110 through nipple assembly 107 during a first (e.g., at-home) feeding operation, and FIG. 2B depicts travel-type bottle assembly 102 in the feeding/open configuration and in an inverted orientation that facilitates suckling of milk by an infant (not shown) from multi-chamber bottle structure 120 through nipple assembly 107 during a second (e.g., away from home) feeding operation.

Referring to FIG. 2A, home-type bottle assembly 101 is prepared for use, for example, by way of attaching bottom vent assembly 108 to lower flange 116 of single-chamber bottle structure 110, inserting water and formula through neck 113 into chamber 112, attaching nipple assembly 107 to neck 113 to complete home-type bottle assembly 101, and then shaking home-type bottle assembly 101 to form milk M by intermixing the formula and water in chamber 112. Once the formula and milk are sufficiently mixed, home-type bottle assembly 101 may be presented to an infant in the inclined orientation indicated in FIG. 2B such that milk M may be suckled through nipple assembly 107. Note that chamber 112 extends the entire length of bottle assembly 101 (i.e., from feeding duct 179 to anti-colic venting device 190) such that, as an amount of milk DM is drawn through feeding duct 179 by an infant, the reduced liquid volume generates a reduction in internal pressure P₁₁₂ (i. e., air pressure inside chamber 112). As mentioned above, when internal pressure P₁₁₂ drops a predetermined amount below atmospheric pressure P_{ATM} (i. e., the ambient air pressure outside bottle assembly 101), anti-colic venting device 190 actuates to allow an amount of vented air VA to enter chamber 112, whereby internal pressure P₁₁₂ is maintained relatively constant (i.e., slightly below atmospheric pressure P_{ATM}). After the feeding session is completed, bottle assembly 101 is disassembled and single-chamber bottle structure 110 is cleaned, for example, using a bottle brush. A possible advantage of providing single-chamber bottle structure 110 with both upper opening 115 and lower opening 118 is that the two opposing openings may facilitate more thorough cleaning (i.e., in comparison to bottle structures having a single opening).

According to an aspect of the invention, a method for priming a travel-type bottle assembly (i.e., setting-up/preparing the assembly for feeding an infant at a subsequent time) includes inserting formula F and water W through separate openings into powder chamber 132 and water chamber 142 of multi-chamber bottle structure 110 (e.g., inserting formula F through upper opening 113 and water through lower opening 118) while mixing control mechanism 150 is maintained in the travel/closed configuration. Referring to the right side of FIG. 1, in one embodiment this priming process begins by assembling or otherwise configuring multi-chamber bottle structure 120 such that mixing control mechanism 150 is in the travel/closed configuration (e.g., as shown in FIG. 1, such that control structure 151 (T1) includes a watertight barrier (e.g., wall 131-1) between powder chamber 132 and water chamber 142). After multi-chamber bottle structure 120 is assembled and control structure 151 (T1) is adjusted into the travel/closed configuration, formula F and water W are inserted into and sealed inside powder chamber 132 and water chamber 142, respectively. For example, a pre-measured amount of formula F may be inserted through upper opening 133 and then enclosed (sealed) within powder chamber 132 by way of attaching nipple assembly 107 to neck 133, and then a premeasured amount of water W may be inserted through lower opening 148 and bottom vent assembly 108 attached to lower flange 146. Conversely, water W may be inserted into and sealed inside lower opening 148, and then formula F may be inserted into and sealed inside powder chamber 132. Travel-type bottle assembly 102 is considered primed at a given time when formula F and water W have been inserted and nipple assembly 107 and bottom vent assembly 108 have been attached as described above, and mixing control mechanism 150 has been maintained in the travel/closed configuration from the beginning of the priming process to the given time. In one embodiment the assembly, insertion and sealing processes described above are preferably performed in a sanitary setting (such as at a user's home). FIG. 1 depicts travel-type bottle assembly 102 at time T1, which occurs after completion of the above-mentioned priming process and before travel-type bottle assembly 102 is utilized to feed an infant (described below with reference to FIG. 2B). Note that mixing control mechanism 150 is maintained in the travel/closed configuration the entire time period between assembly of bottle assembly 120 (i.e., before insertion and sealing of formula F and water W in their respective chambers) and time T1. until mixing control mechanism 150 is actuated or otherwise reconfigured into the feeding (open) configuration.

FIG. 2B depicts travel-type bottle assembly 102 at a time T2 after mixing control mechanism 150 is actuated such that bottle assembly 120 is adjusted (reconfigured) from the travel configuration (depicted in FIG. 1) to the feeding configuration. The actuation of mixing control mechanism 150 is depicted in FIG. 2B by the reconfiguration of control structure 151 (T2) (i.e., the effective removal of wall 131-1) such that powder chamber 132 communicates with water chamber 142 by way of flow passage 125. That is, flow passage 125 provides an opening that effectively combines (links) powder chamber 132 and water chamber 142 to form a combined chamber 122), whereby water is allowed to intermix with formula to form milk M within combined chamber 122. Note that combined chamber 122 extends substantially the entire length of bottle assembly 102 (i.e., from feeding duct 179 through chambers 132 and 142 to bottom cap 180) such that, as an amount of milk DM is drawn through feeding duct 179 by an infant, the reduced liquid volume generates a reduction in internal pressure P₁₂₂ (i.e., air pressure inside chamber 122). When internal pressure P₁₂₂ drops a predetermined amount below atmospheric pressure, anti-colic venting device 190 actuates to allow an amount of vented air VA to enter chamber 122, whereby internal pressure P₁₂₂ is maintained relatively constant and at the same pressure level as internal pressure P₁₁₂ (described above with reference to FIG. 2A). After the feeding session is completed, bottle assembly 102 is disassembled and the various components of multi-chamber bottle structure 120 are separately cleaned for subsequent use.

According to an aspect of the present invention, baby feeding system 100 avoids nipple confusion by providing both home-type bottle assembly 101 (FIG. 2A) and travel-type bottle assembly 102 (FIG. 2B) with substantially identical mouth feels and drinking performances. That is, by configuring neck 113 of single-chamber bottle structure 110 and neck 133 of multi-chamber bottle structure 120 to operably receive and utilize nipple assembly 107 (or two substantially identical nipple assemblies), an infant experiences the same nipple shape and feel when drawing milk through feeding duct 179 from either the home-type bottle assembly 101 or travel-type bottle assembly 102. Moreover, by configuring lower flange 116 of single-chamber bottle structure 110 and lower flange 146 of multi-chamber bottle structure 120 to operably receive and utilize bottom vent assembly 108 (or two substantially identical bottom vent assemblies), an infant experiences substantially the same amount of suckling pressure (i.e., the same drinking performance) when feeding from either bottle assembly. That is, by utilizing bottom vent assembly 108 in both home-type bottle assembly 101 (FIG. 2A) and travel-type bottle assembly 102 (FIG. 2B), internal pressure P₁₂₂ inside chamber 122 of travel-type bottle assembly 102 is maintained substantially equal to internal pressure P₁₁₂ inside chamber 112 of home-type bottle assembly 101. Accordingly, baby feeding system 100 avoids nipple confusion because both home-type bottle assembly 101 and travel-type bottle assembly 102 exhibit substantially identical mouth feel and drinking performance.

According to another aspect of the present invention, by forming multi-chamber bottle structure 120 with two openings (i.e., both upper opening 135 and lower opening 148), travel-type bottle assembly 102 avoids the bacterial growth problem associated with some conventional travel bottles (as described above). That is, in addition to facilitating the use of bottom vent assembly 108, lower opening 148 facilitates the insertion of water W during the priming process in a way that prevents/avoids the occurrence of residual moisture in powder chamber 132. Specifically, by setting control structure 151 (T1) into the closed (travel) configuration (as shown in FIG. 1) prior to the insertion of water W through lower opening 148 and sealing inside water chamber 142 by way of operably connecting bottom vent assembly 108 to lower flange 116, the present invention prevents the occurrence of residual moisture in powder chamber 132, thereby avoiding the bacterial growth problem associated with some conventional travel bottles.

FIG. 3 shows a baby feeding system 100A according to a specific embodiment including a single-chamber bottle structure 110A, a multi-chamber bottle structure 120A, a nipple assembly 107A and a bottom vent assembly 108A. Similar to system 100 (described above), both single-chamber bottle structure 110A and multi-chamber bottle structure 120A are configured to utilize nipple assembly 107A and bottom vent assembly 108A. The structure and function of single-chamber bottle structure 110A may be substantially identical to those of bottle structure 110 of system 100, but multi-chamber bottle structure 120A, nipple assembly 107A and bottom vent assembly 108A include additional features not described above with reference to system 100. The various components of system 100A are shown in cross-sectional view in a form that is simplified for descriptive purposes, and the relative sizes and shapes of the components are not intended to represent a fixed scale and/or actual structural configuration.

Single-chamber bottle structure 110A includes a substantially cylindrical peripheral wall 111A surrounding a chamber 112A, a cylindrical neck 113A integrally connected to and located at an upper end of peripheral wall 111A and surrounding an upper opening 115A, and a cylindrical lower flange 116A integrally connected to and located at a lower end of peripheral wall and surrounding a lower opening 118A. Neck 113A has an outer diameter DO11 and external threads 114A that are configured to mate with nipple assembly 107A, and lower flange 116A has an outer diameter DO21 and includes external helical threads 117A that are configured to mate with a bottom cap 180A of bottom vent assembly 108A. When nipple assembly 107A and bottom vent assembly 108A are operably connected, single-chamber bottle structure 110A provides a home-type bottle assembly similar to that described above with reference to FIG. 2A.

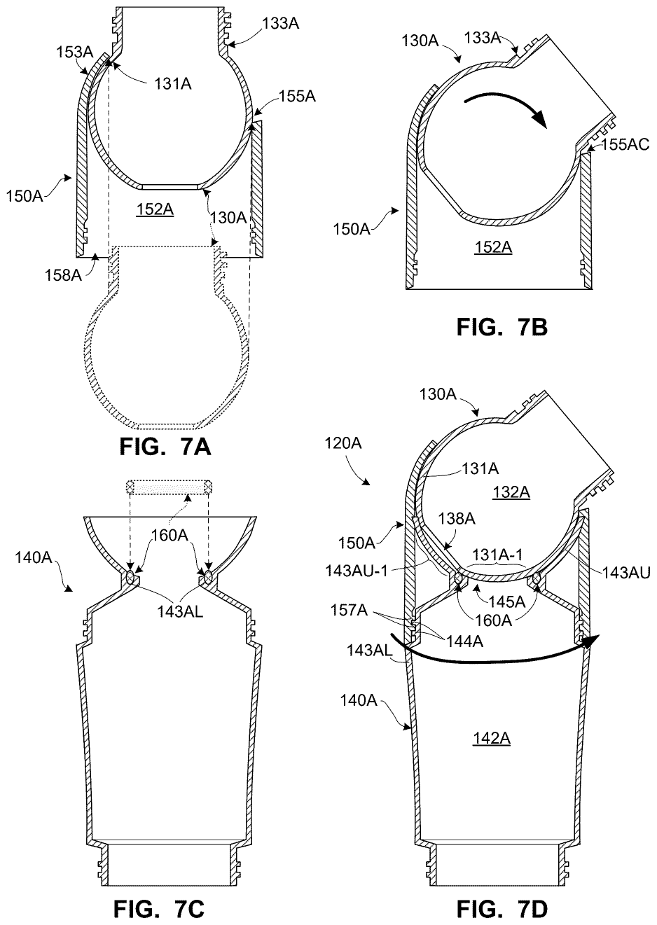

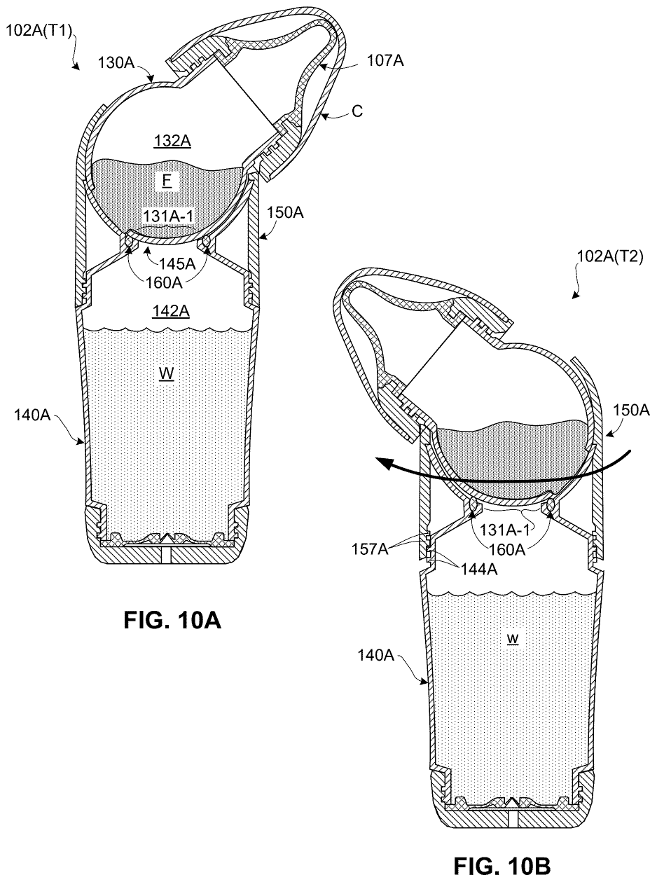

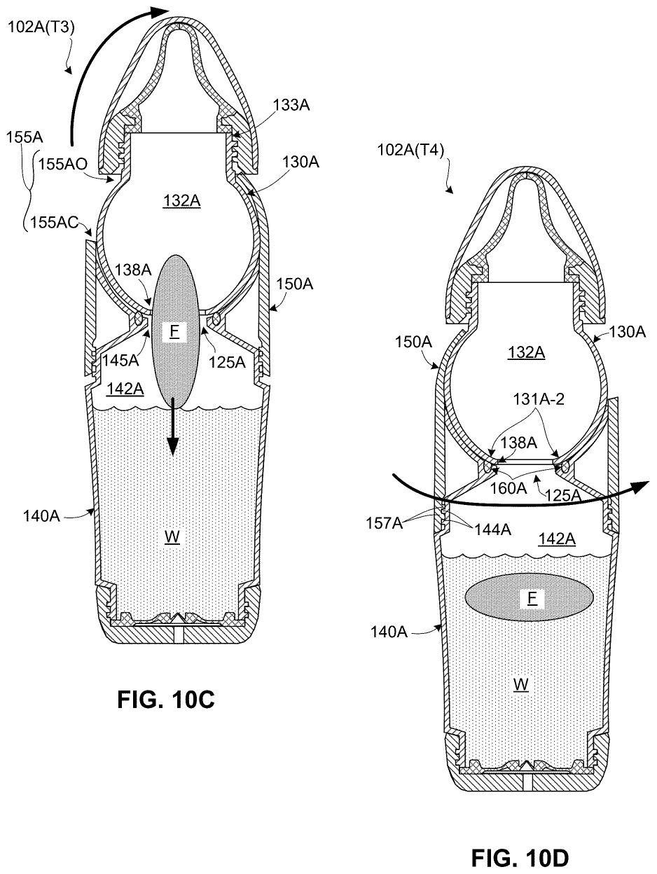

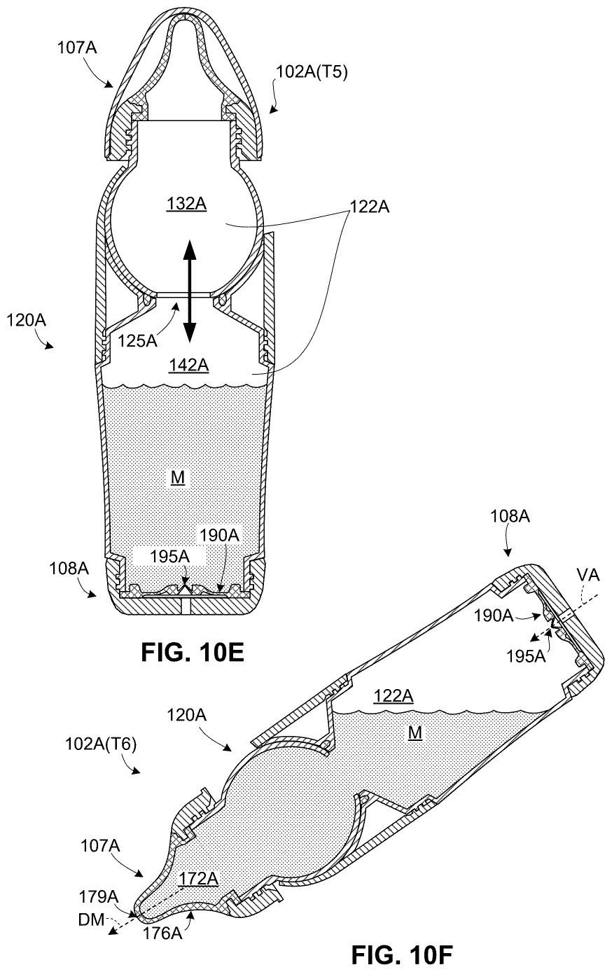

Referring to the right side of FIG. 3, multi-chamber bottle structure 120A includes a hollow ball member 130A, a container body (body) 140A, and housing 150A and an O-ring 160A. As described below with reference to FIGS. 7A to 7C, when operably assembled these structures collectively form a ball-valve-type (ball-type) bottle assembly. Hollow ball member 130A includes a spherical (curved) peripheral wall 131A that surrounds a powder chamber 132A and a neck 133A extending from an upper end thereof. Neck 133A is integrally connected to the upper end of spherical wall 131A and is implemented as a cylindrical structure having outer diameter DO12 and having exterior threads 134A formed thereon such that neck 133A is configured to mate with nipple assembly 107A. Neck 133A surrounds an upper opening 135A and spherical wall 131A defines a lower opening 138A at a lower end thereof, where both upper opening 135A and lower opening 138A communicate with powder chamber 132A. In an exemplary practical embodiment upper opening 135A is one to one and one-half inches in diameter to facilitate entry of formula into powder chamber 132A, and lower opening 138A is preferably one inch or more in diameter to facilitate thorough mixing of the formula with water stored in the body 140A as described below. Referring to the lower right portion of FIG. 3, body 140A includes a substantially cylindrical peripheral wall 141A surrounding a water chamber 142A. Integrally molded at the upper end of peripheral wall 141A is an upper flange 143A including a lower cylindrical flange portion 143AL, a central tapered flange portion 143AM and an upper bowl-like flange portion 143AU. Cylindrical flange portion 143AL includes exterior helical threads 144A that are configured to mate with corresponding threads 157A of housing 150A. Disposed on an inside surface of tapered flange portion 143AM is an annular O-ring groove 143AO that defines (surrounds) an upper opening 145A. In one embodiment tapered flange portion 143AM is configured such that upper opening 145A, which forms one of two openings into water chamber 142A, has a diameter of at least one inch to facilitate the intermixing of formula and water. Bowl-like flange portion 143AU extends upward from tapered flange portion 143AL and has the shape of a spherical segment or spherical frustum (i.e., with upper opening 145A formed in its central region). As described in additional detail below, bowl-like flange portion 143AU functions as a ball socket that is configured to rotatably/slidably receive hollow ball member 130A. Integrally molded at the lower end of peripheral wall 141A is a cylindrical lower flange 146A having an outer diameter DO22 and surrounds a lower opening 148A that communicates with water chamber 142A. Exterior helical threads 144A are formed on an outside surface of lower flange 146A. Housing 150A includes a cylindrical peripheral wall 151A that substantially surrounds an interior region 152A. The upper end of peripheral wall 151A includes a shoulder 153A and defines an actuating slot (slot-like upper opening) 155A and a lower end of peripheral wall 151A includes a bottom opening 158A. A set of interior helical threads 157A is formed on an inside surface of peripheral wall 151A near bottom opening 158A. As described below, bottom opening 158A and interior region 152A are configured to receive ball member 130A (i.e., such that ball member 130A can be inserted through bottom opening 158A into interior region 152A). Shoulder 153A and upper opening 155A are configured such that neck 133A extends through slot-like upper opening 155A and a portion of spherical peripheral wall 131A contacts shoulder 153A when ball member 130A is fully operably inserted into interior region 152A. When fully inserted, subsequent rotation/pivoting of ball member 130A relative to housing 150A is restricted by contact between neck 133A and slot-like upper opening 155A, whereby movement of ball member 130A relative to body 140A is limited to rotation/pivoting between an open position, in which neck 133A is located in an open slot portion 155AO of upper opening 155A, and a closed position, in which neck 133A is positioned in a closed slot portion 155AC of upper opening 155A. As set forth below, when ball member 130A is operably mounted inside housing 150A and interior threads 157A are mated with exterior threads 144A of base 140A, housing 150A functions to hold (retain) ball member 130A such that a portion of ball member 130A contacts upper flange 143AU of body 140A and O-ring 160A. In addition, hollow ball member 130A, housing 150A and body 140A are configured such that, when housing member 150A is rotated into a fully tightened position (e.g., as described below with reference to FIGS. 10A and 10D), hollow ball member 130A is effectively locked in either a closed (travel) or open (feeding) configuration (i.e., such that rotation of ball member 130A relative to body 140A is prevented).

Container body 140A, housing 150A, and hollow ball member 130A are molded from a plastic that is strong enough to withstand the biasing pressure when assembled in the manner shown in FIG. 7D such that housing 140A biases hollow ball member 130A against upper flange 143AU and O-ring 160A. Further, the preferred plastic is Food and Drug Administration approved for food storage, exhibits sufficient lubricity for smooth sliding without the need for lubricants, and is not structurally or chemically altered when subjected to cleaning temperatures of up to 100° C. Several plastic materials are currently available which can be modified using known methods to meet the preferred characteristics discussed above, such as polyethylene, polypropylene, and polycarbonate. Combinations of these materials can also be used (e.g., container body 140A and housing 150A formed using polycarbonate, and ball member 130A formed using polypropylene).

O-ring 160A is an annular rubber structure that operably fits within O-ring groove 143AO formed on flange 143A of body 140A. As indicated in the dashed-line circle in FIG. 3, O-ring 160A may be provided with a non-circular cross-sectional shape (i.e., such that its height H measured in an axial direction A is greater than its width W measured in radial direction R) to enhance its ability to form a water proof seal with hollow ball member 130A during operation. In some embodiments O-ring 160A includes a collared configuration such as that described in U.S. Pub. App. US 20040134222 A1 (incorporated herein by reference) to facilitate forming a reliable seal against hollow ball member 130A using a relatively low applied pressing force.

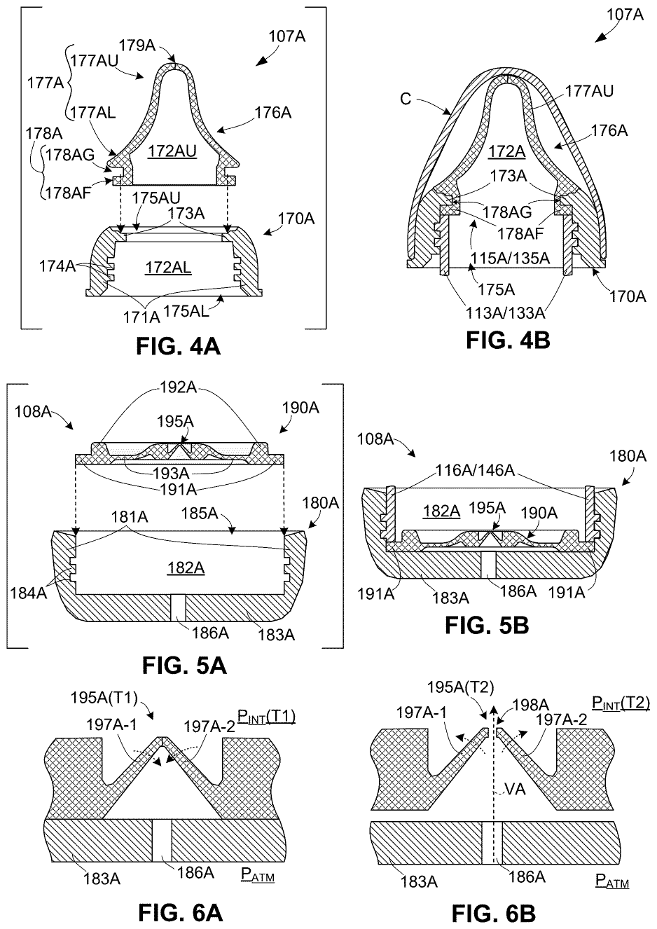

FIGS. 4A and 4B depict nipple assembly 107A in exploded and assembled configurations. Referring to FIG. 4A, nipple assembly 107A includes a hard plastic collar 170A and a silicone teat 176A. Collar 170A is a rigid plastic molded structure including a substantially cylindrical wall structure 171A and includes interior helical threads 174A that are configured to mate with exterior threads 114A of single-chamber bottle 110A and exterior threads 134A of multi-chamber bottle 120A (both shown in FIG. 3). Wall structure 171A surrounds a lower flow passage portion 172AL and has a lower opening 175AL configured to receive the necks of bottle structures 110A and 120A, and an upper opening 175AU configured to receive a lower portion of teat 176A. As indicated in FIG. 3, wall structure 171A has an inner diameter DI1 that slightly larger than outer diameters DO11 of neck 113A of single-chamber bottle 110A and neck 133A of multiple-chamber bottle structure 120A and is therefore sized and configured to alternately operably connect to both bottle structures 110A and 120. An annular nipple flange 173A is formed at the upper end of wall structure 171A and surrounds upper opening 175AU. Teat 176A includes a substantially dome-shaped wall 177A that surrounds an upper flow passage portion 172AU and tapers from a relatively wide lower end portion 177AL to an upper end portion 177AU. One or more normally closed feeding ducts 179A are formed through upper end portion 177AU of dome-shaped wall 177A. An annular connecting structure 178A is integrally formed on lower end portion 177AL and includes a groove 178AG and a sealing flange 178AF. FIG. 4B shows nipple assembly 107A after teat 176A is operably connected to collar 170A and after nipple assembly 107A is operably connected to either neck 113A of single-chamber bottle structure 110A or neck 133A of multi-chamber bottle structure 120A (both bottle structures 110A and 120A are shown in FIG. 3). When teat 176A is operably connected to collar 170A, annular nipple flange 173A is received inside groove 178AG and sealing flange 178AF is disposed below nipple flange 173A. When nipple assembly 107A is subsequently operably connected to either single-chamber bottle structure 110A or multi-chamber bottle structure 120A (i.e., by way of inserting neck 113A or neck 133A through lower opening 175AL and operably engaging threads 114A/134A with threads 174A), sealing flange 178AF is pinched between an upper edge of neck 113A/133A and annular nipple flange 173A, whereby teat 176A substantially encloses upper openings 115A/135A (i.e., such that fluid passing through necks 113A/133A can only exit nipple assembly 107A by way of feeding duct 179A). As also indicated in FIG. 4B, nipple assembly 107A may include an optional dome-shaped cap C that mounts over teat 176A and connects to collar 170A.

FIGS. 5A and 5B depict bottom vent assembly 108A in exploded and assembled configurations. Referring to FIG. 5A, bottom vent assembly 108A includes a bottom cap 180A and an anti-colic vent device 190A. Bottom cap 180A is an integral rigid plastic molded structure including a cylindrical wall structure 181A that surrounds an inner cap region 182A and a disk-shaped cover plate 183A integrally connected to a lower end of wall structure 181A. Cylindrical wall structure 181A includes interior helical threads 184A that are configured to engage with exterior threads 117A of single-chamber bottle 110A and exterior threads 147A of multi-chamber bottle 120A (both shown in FIG. 3). As indicated in FIG. 3, wall structure 181A has an inner diameter DI2 that is slightly larger than outer diameters DO21 of lower flange 116A of single-chamber bottle 110A and lower flange 146A of multiple-chamber bottle structure 120A and is therefore sized and configured to be alternately operably connectable to both bottle structures 110A and 120A by way of an upper opening 185A. Cover plate 183A substantially encloses a lower end of inner cap region 182A and includes one or more vent openings 186A. Vent device 190A includes an elastomeric membrane structure having a circular peripheral edge 191A that is sized to operably connect to bottom cap 180A (e. g., to fit within inner cap region 182A such that peripheral edge 191A presses against the lower inside edge of cylindrical wall structure 181A). Vent device 190A also includes an annular support rib 192A that surrounds an inner membrane 193A, and inner membrane 193A includes at least one normally closed flap-type vent device (pressure regulating feature) 195A. FIG. 5B shows bottom vent assembly 108A after vent device 190A is operably connected to bottom cap 180A and after bottom cap assembly 108A is operably connected to either lower flange 116A of single-chamber bottle structure 110A or lower flange 146A of multi-chamber bottle structure 120A (both bottle structures 110A and 120A are shown in FIG. 3). When vent device 190A is operably connected to bottom cap 180A at least a portion of the elastomeric structure (e.g., peripheral edge 191A) contacts an inner surface of cover plate 183A. When bottom vent assembly 108A is subsequently operably connected to either single-chamber bottle structure 110A or multi-chamber bottle structure 120A (i.e., by way of inserting lower flange 116A or lower flange 146A through opening 185A and operably engaging threads 117A/147A with threads 184A), peripheral edge 191A is pinched between a lower edge of lower flange 116A/146A and cover plate 183A, whereby vent device 190A substantially encloses (seals) lower openings 118A/148A. Note that peripheral edge 191A is locked in place (i.e., prevented from moving relative to bottom cap 180A) by way of being pinched between the lower edge of lower flange 116A/146A and cover plate 183A, but a central portion of the elastomeric membrane structure including flap-type vent device 195A is free to move toward or away from cover plate 183A.

FIGS. 6A and 6B depict the operating state of a portion of flap-type vent device 190A including flap-type vent device 195A at two different times T1 and T2. FIG. 6A shows flap-type vent device 195A at time T1 when an external pressure P_{ATM} (e.g., atmospheric pressure outside of a bottle assembly utilizing vent device 190A) is lower than an internal pressure P_{INT}(T1) (i.e., pressure inside the bottle assembly), where external pressure PAIM is applied to one side of vent feature 195A by way of vent opening 186A. Note that flap-type vent device 195A represents a one-way pressure-regulating feature including opposing flaps 197A-1 and 197A-2 that are biased toward each other (i.e., toward cover plate 183A, as indicated by the dashed arrows) when internal pressure P_{INT}(T1) is equal to or greater than external pressure P_{ATM}. This configuration causes vent feature 195A to remain closed to prevent the leakage of milk or water whenever interior bottle pressure P_{INT}(T1) is equal to or greater than atmospheric pressure P_{ATM} (e.g., when the bottle assembly is being transported or during periods when milk is not being consumed by an infant). FIG. 6B shows flap-type vent device 190A at time T2 when external pressure P_{ATM} is a predetermined amount greater than an internal pressure P_{INT}(T2) (e.g., when milk is drawn from the bottle assembly by a suckling infant). The relatively high external pressure and relatively low internal pressure P_{INT}(T2) cause opposing flaps 197A-1 and 197A-2 to bend away from each other (i.e., away from cover plate 183A, as indicated by the dashed arrows) thereby separating to form an opening 198A through which vented air VA is able to pass through vent feature 195A-1 (T2) into the bottle assembly by way of vent opening 186A, whereby the internal pressure is regulated (e.g., maintained at a level that is slightly below atmospheric pressure P_{ATM}).

FIGS. 7A to 9B illustrate an exemplary priming (set-up) process during which water and formula are inserted into multi-chamber bottle structure 120A and enclosed by nipple assembly 107A and bottom vent assembly 108A. FIGS. 7A to 7D depict an initial phase of the priming process during which multi-chamber bottle structure 120A is assembled and securely configured in the closed (travel) configuration.

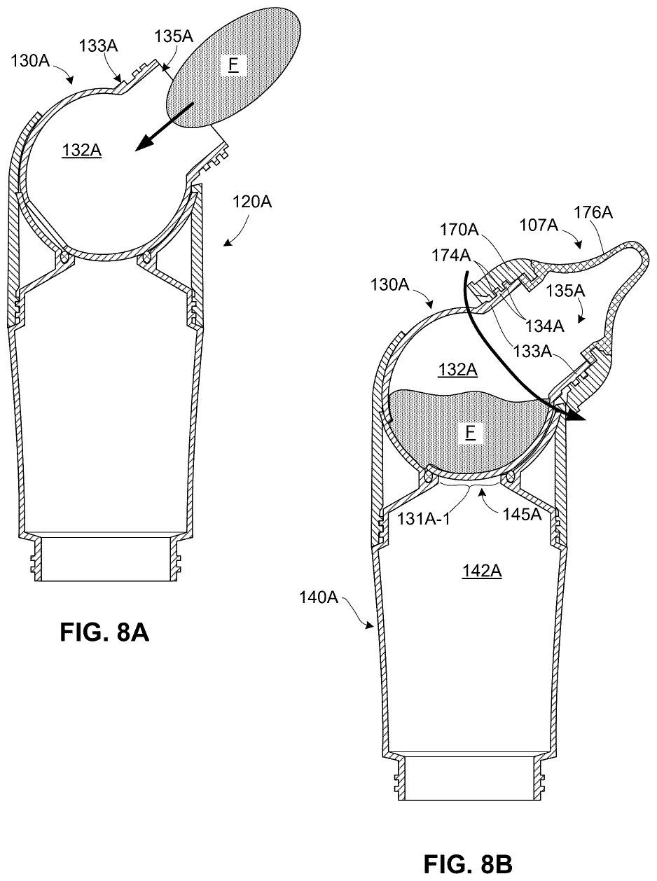

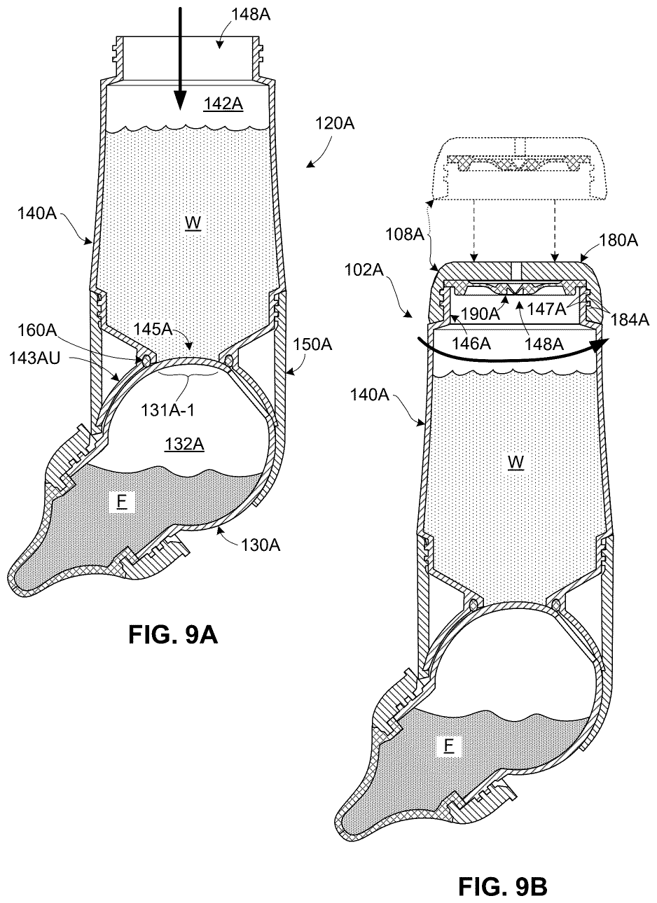

FIGS. 8A to 9B depict a second phase of the priming process during which formula and water are separately inserted and sealed inside multi-chamber bottle structure 120A.

FIGS. 7A to 7D depict an exemplary assembly operation that is performed at the beginning of the priming process. FIG. 7A depicts the insertion of hollow ball member 130A through bottom opening 158A into interior region 152A of housing 150A until neck 133 extends through slot 155A and peripheral wall 131A contacts shoulder 153A. FIG. 7B depicts the rotation of hollow ball member 130A (as indicated by the curved arrow) within interior region 152A of housing 150A until neck 133A is disposed in closed slot portion 155AC. FIG. 7C depicts the insertion of O-ring 160A into groove 143AL of body 140A. FIG. 7D depicts the subsequent attachment of housing 150A and hollow ball member 130A onto body 140A. Threads 157A are engaged (mated) with threads 144A and then housing 150A and hollow ball member 130A are rotated relative to body 140A (as indicated by the curved arrow in FIG. 7D) until further rotation is prevented, for example, by contact between a lower portion of housing wall 151A and lower flange portion 143AL. When housing 150A is tightly secured to body 140A, hollow ball member 130A is pressed against O-ring 160A and/or upper flange 143AU. Note that, when housing 150A is tightly connected to body 140A in this manner, a portion 131A-1 of peripheral wall 131A is disposed over upper opening 145A and pressed against O-ring 160A, thereby providing a waterproof barrier between powder chamber 132A and water chamber 142A. Note also that friction between O-ring 160A and peripheral wall 131A resists rotation of hollow ball member 130A relative to body 140A while housing 150A remains tightly secured to body 140A. Although FIGS. 7A to 7D depict a specific assembly sequence, it is understood that the assembly sequence may be altered, provided the end result is a secure connection of housing 150A to body 140A with hollow ball member 130A maintained in the closed position, as shown in FIG. 9D. FIGS. 8A to 9B depict the second phase of the priming process involving the insertion and enclosing of water and formula inside multi-chamber bottle structure 120A. FIG. 8A depicts the insertion of a predetermined amount of formula F through upper opening 135A into powder chamber 132A of hollow ball member 130A.

FIG. 8B depicts the attachment of nipple assembly 107A onto neck 133A by way of engaging threads 134A and 174A and rotating nipple assembly 107A relative to hollow ball member 130A (as depicted by the curved arrow in FIG. 8B). Once nipple assembly 107A is fully attached, formula F is enclosed/sealed inside powder chamber 132A (i.e., teat 176A prevents formula F from exiting powder chamber 132A through upper opening 135A, and wall portion 131A-1 prevents formula F from exiting powder chamber 132A through upper opening 145A of body 140A). FIG. 9A depicts the insertion of a predetermined amount of water W through lower opening 148A into water chamber 142A of body 140A. Note that, because housing 150A presses hollow ball member 130A against upper flange 143AU and O-ring 160A with wall portion 131A-1 positioned over upper opening 145A of body 140A, water W is prevented from exiting water chamber 142A and entering powder chamber 132A. FIG. 9B depicts the attachment of bottom valve assembly 108A onto lower flange 146A by way of engaging threads 147A and 184A and rotating bottom cap 180A relative to body 140A (as depicted by the curved arrow in FIG. 9B). Once lower cap 180A is tightly secured, water W is enclosed/sealed inside water chamber 142A (i.e., anti-colic venting device 190A prevents water W from exiting water chamber 142A through lower opening 148A, and wall portion 131A-1 prevents water W from exiting water chamber 142A through upper opening 145A). Note that FIG. 9B depicts a primed travel-type bottle assembly 102A including multi-chamber bottle structure 120A, nipple assembly 107A and bottom vent assembly 108A, and that the priming process depicted in FIGS. 7A to 9B may be conducted at home or in another safe and sanitary environment. Although FIGS. 8A to 9B depict the insertion/enclosing of formula into bottle structure 120A before the insertion/enclosing of water, it is understood that this order may be reversed (i. e., water may be inserted before formula).

FIGS. 10A to 10F show actuation (formula/water mixing operation) and subsequent use of travel-type bottle assembly 102A. FIG. 10A shows travel-type bottle assembly 102A at a time T1 occurring a period of time after completion of the priming process described above with reference to FIGS. 8A to 9B, and immediately before the actuation process described below with reference to FIGS. 10B to 10E. Note that travel-type bottle assembly 102A(T1) remains in the closed/travel configuration (i.e., with wall portion 131A-1 of spherical (curved) wall 131A positioned to cover upper opening 145A to prevent intermixing of formula F and water W), and that friction between hollow ball member 130A and O-ring 160A prevents rotation of hollow ball member 130A. Accordingly, hollow ball member 130A remains “locked” in the closed/travel configuration until the downward pressure applied by housing 150A on hollow ball member 130A is reduced. While primed and locked in the closed/travel configuration, travel-type bottle assembly 102A protects formula F and water W from external contaminants, thereby allowing travel-type bottle assembly 102A to be conveniently transported away from the sanitary conditions provided at home desired location. During this time cap C may be attached to prevent contamination of nipple assembly 107A. FIGS. 10B to 10E illustrate how travel-type bottle assembly 102A may be actuated to mix formula F with water W without exposing either substance to potential contaminants. FIG. 10B shows travel-type bottle assembly 102A at a time T2 when housing 150A is loosened by way of being rotated relative to body 140A (indicated by the curved arrow in FIG. 10B), whereby the sliding engagement of threads 157A and threads 144A causes housing 150A to move slightly upward relative to body 140A. FIG. 10C shows travel-type bottle assembly 102A at a time T3 after hollow ball member 130A is manually rotated upward (as indicated by the curved arrow in FIG. 10C) such that lower opening 138A of hollow ball member 130A aligns with upper opening 145A of body 140A, thereby forming a flow passage 125A between powder chamber 132A and water chamber 142A that allows formula F to intermix with water W (as indicated by the downward pointing arrow in FIG. 10C). Note that loosening housing 150A (as described with reference to FIG. 10B) reduces the friction force applied to hollow ball member 130A by O-ring 160A, thereby allowing hollow ball member 130A to be rotated or pivoted relative to body 140A and housing 150A such that neck 133A slides from closed end 155AC to open end 155AO of actuating slot 155A. FIG. 10D shows travel-type bottle assembly 102A at a time T4 when housing 150A is retightened (indicated by the curved arrow in FIG. 10D) while hollow ball member 130A is in the open position, whereby the sliding engagement of threads 157A and threads 144A causes housing 150A to reapply a downward force on hollow ball member 130A such that contact between O-ring 160A and a circular portion 131A-2 of spherical wall 131A surrounding lower opening 138A forms a seal around flow passage 125A (i.e., such that water/milk is able to flow between chambers 132A and 142A without leaking). FIG. 10E travel-type bottle assembly 102A at a time T5 after being vigorously manually shaken (as indicated by the two-headed arrow in FIG. 10E) until the formula and water are thoroughly mixed to form milk M. Note that milk M is retained within combined chamber 122A (i.e., powder chamber 132A and water chamber 142A joined by flow passage 125A) of multi-chamber bottle structure 120A during the shaking/mixing process by way of nipple assembly 107A and bottom vent assembly 108A (i.e., milk M is prevented from exiting combined chamber 122A through upper opening 135A by teat 176A, and prevented from exiting through lower opening 148A by anti-colic venting device 190A). Note also that housing 150A is not detached/removed from body 140A at any point during the actuation process described with reference to FIGS. 10B to 10E, whereby travel-type bottle assembly 102A prevents the possible exposure of formula F, water W and milk M to contaminants in the surrounding environment during the actuation and shaking/mixing processes.

FIG. 10F shows travel-type bottle assembly 102A at a time T6 during a subsequent feeding process after the cap is removed from nipple assembly 107A and milk is drawn from bottle structure 120A through teat 176A by an infant (not shown). During the feeding process bottle assembly 120 is inclined such that milk M is able to flow from combined chamber 122A through flow passage 172A and feeding duct 179A by the infant. As milk DM is drawn through feeding duct 179A, the reduced liquid volume generates a reduction in pressure inside chamber 122A, thereby causing flap-type vent device 195A to open, whereby an amount of vented air VA enters chamber 122A by way of anti-colic venting device 190A (as indicated by the dashed-line arrow).

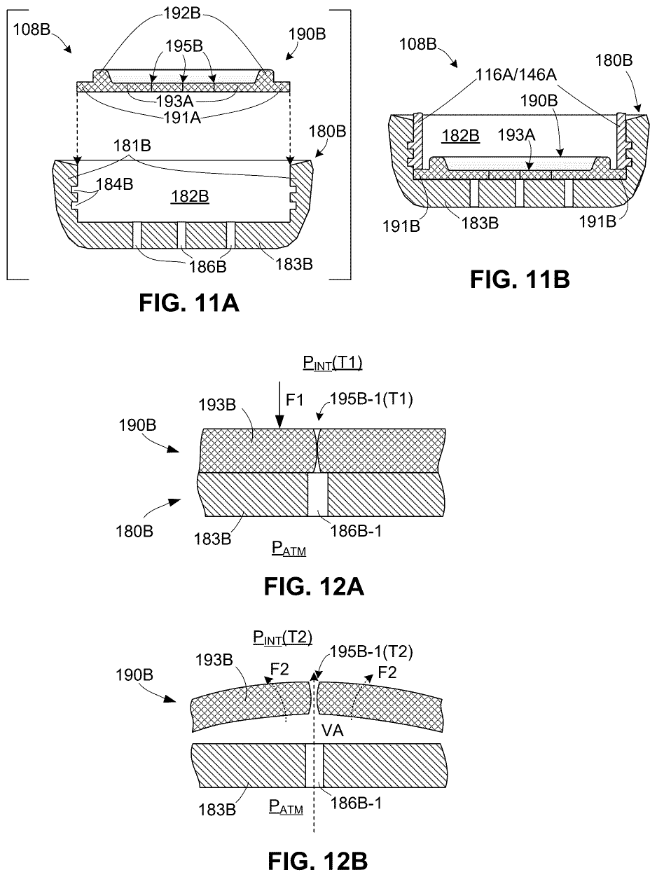

FIGS. 11A and 11B depict a bottom vent assembly 108B according to an alternative specific embodiment that may be used in place of bottom vent assembly 108A (described above with reference to FIGS. 5A and 5B).

Referring to FIG. 11A, bottom vent assembly 108B includes a bottom cap 180B and an anti-colic vent device 190B. Bottom cap 180B includes a cylindrical wall structure 181B including internal threads 184B that surrounds an inner cap region 182B and an integral disk-shaped cover plate 183A having vent openings 186B, where bottom cap 180B is configured and functions substantially as described above with reference to bottom cap 180A (see description referencing FIGS. 5A and 5B). Vent device 190B includes an elastomeric membrane structure having a circular peripheral edge 191B that is sized to operably connect to bottom cap 180B (e.g., to fit within inner cap region 182B such that peripheral edge 191B presses against the lower inside edge of cylindrical wall structure 181B). Vent device 190B also includes an annular support rib 192B that surrounds an inner membrane 193B, and at least one normally closed pinhole-type vent device (feature) 195B is formed on inner membrane 193B. FIG. 11B shows bottom vent assembly 108B after vent device 190B is operably connected to bottom cap 180B and after bottom cap assembly 108B is operably connected to either lower flange 116A of single-chamber bottle structure 110A or lower flange 146A of multi-chamber bottle structure 120A (both bottle structures 110A and 120A are shown in FIG. 3).

When vent device 190B is operably connected to bottom cap 180B both peripheral edge 191B and inner membrane 193B contact an inner surface of cover plate 183B. When bottom vent assembly 108B is subsequently operably connected to either single-chamber bottle structure 110A or multi-chamber bottle structure 120A (i.e., by way of inserting lower flange 116A or lower flange 146A into inner cap region 182B and operably engaging threads 117A/147A with internal threads 184B), peripheral edge 191B is pinched between a lower edge of lower flange 116A/146A and the inside surface of cover plate 183B.

FIGS. 12A and 12B depict portions of vent device 195B (including a single pinhole-type vent device 195B-1) and bottom cap 180B at two different times T1 and T2. FIG. 6A shows pinhole-type vent device 195B-1 at a time T1 when an external pressure P_{ATM} (e. g., atmospheric pressure outside of a bottle assembly utilizing vent device 190B) is lower than an internal pressure P_{INT}(TI) (i.e., a pressure inside the bottle assembly), where external pressure P_{ATM} is applied to one side of vent device 190B by way of vent opening 186B. Pinhole-type vent device 195B-1 represents a one-way pressure-regulating feature in that it remains closed when the higher internal pressure P_{INT}(T1) biases membrane 193B against the upper (inside) surface of cover plate 183B, thereby preventing the leakage of milk or water whenever interior bottle pressure P_{INT}(T1) is equal to or greater than atmospheric pressure P_{ATM}. Note that cover plate 183B acts as a support plate that prevents membrane 193B from bowing outward (downward in FIG. 12A). FIG. 12B shows vent device 190B at time T2 when external pressure PATM is greater than an internal pressure P_{INT}(T2), whereby the relatively high external pressure and relatively low internal pressure P_{INT}(T2) cause membrane 193B to stretch (bow) upward (away from cover plate 183B), thereby causing pinhole-type vent device 195-1 (T2) to open and allow vented air VA to pass into the bottle assembly by way of vent opening 186B, whereby internal pressure P_{INT}(T2) is maintained at a predetermined level that is slightly below atmospheric pressure PATM.

Those skilled in the art will recognize that the number of pinhole-type vent devices 195B, and the diameter, thickness and flexibility of membrane 193B combine to produce the venting characteristics of pinhole-type venting device 190B. That is, by forming membrane 193B from a relatively flexible, thin elastomeric sheet, using relatively large pins, or providing a relatively large number of pinholes, venting may be caused to occur at relatively low differential pressures. Conversely, by forming membrane 193B from a relatively stiff, thick elastomeric sheet, using relatively small pins, or providing a relatively small number of pinholes, venting may be caused to occur at relatively high differential pressures.

In addition to the specific embodiment disclosed herein, other features and aspects may be added to the novel baby bottle nipple that fall within the spirit and scope of the present invention. For example, although each of the multi-chambered bottle structures described herein includes a powder chamber accessed through a neck and a water chamber accessed through a lower flange, this order may be reversed without significantly altering the operation and function of the resulting travel-type bottle assembly (i.e., water can be inserted through the neck and formula inserted through the lower flange). Moreover, the novel priming process described herein may be beneficially utilized by other travel-type bottle assemblies (e.g., bottle assemblies that utilize a side-or nipple-mounted anti-colic venting device and a solid bottom cap instead of the bottom vent assemblies described above). Therefore, the invention is limited only by the following claims.

1. A baby feeding system comprising:
a single-chamber bottle structure including a first peripheral wall surrounding a first chamber, a first neck located at an upper end of the first peripheral wall and surrounding a first upper opening and a first lower flange located at a lower end of the first peripheral wall and surrounding a first lower opening;
a multi-chamber bottle structure including:
a hollow ball member including a spherical peripheral wall surrounding a second chamber and a second neck located at an upper end of the spherical peripheral wall and surrounding a second upper opening, and
a container body including a first cylindrical peripheral wall that surrounds a third chamber, and a second lower flange located at a lower end of the second first cylindrical peripheral wall and surrounding a second lower opening;
a nipple assembly including a collar that is alternately operably connectable to the first and second necks; and
a bottom vent assembly including a bottom cap that is alternately operably connectable to the first and second lower flanges, and an anti-colic vent device that is operably connected to the bottom cap,
wherein the second neck extends from an upper end of the spherical peripheral wall and a third lower opening is formed at a lower end of the peripheral wall,
wherein the second lower flange extends from a lower end of the cylindrical peripheral wall,
wherein the container body further comprises an upper flange including exterior helical threads, an annular O-ring groove and a bowl-like flange portion formed surround a second upper opening and configured to receive the spherical peripheral wall of the hollow ball member,
wherein the multi-chamber bottle structure further comprises a housing including a second cylindrical peripheral wall, a dome-like upper shoulder that defines a slot-like upper opening disposed at an upper end of the second cylindrical peripheral wall, a bottom opening disposed at a lower end of the second cylindrical peripheral wall, and interior helical threads formed on an inside surface of second cylindrical peripheral wall and configured to mate with the exterior helical threads of the container body, wherein an O-ring disposed in the annular O-ring groove, and
wherein when the hollow ball member is inserted through the bottom opening into the housing such that the second neck extends through the slot-like upper opening and the housing is mounted on the container body such that the interior helical threads are mated with the exterior helical threads, a lower portion of the hollow ball member is received within the bowl-like flange portion and contacts the dome-like upper shoulder against the O-ring.

2. The baby feeding system of claim 1,
wherein the first neck comprises a first cylindrical structure having a first outer diameter and having first exterior threads formed thereon and arranged in a first helical pattern,
wherein the second neck comprises a second cylindrical structure having a second outer diameter and having second exterior threads formed thereon and arranged in a second helical pattern, the second outer diameter being equal to the first outer diameter and the second helical pattern being equal to the first helical pattern, and
wherein the collar comprises a third cylindrical structure having a first inner diameter that is slightly larger than the first and second outer diameters and includes first interior helical threads that are configured to mate with the first and second exterior threads.

3. The baby feeding system of claim 2,
wherein the collar comprises rigid plastic and includes an annular nipple flange that surrounds an upper opening, and
wherein the nipple assembly further comprises an elastomeric teat including a substantially dome-shaped wall that tapers from a relatively wide lower end portion to an upper end portion, one or more normally closed feeding ducts formed through the upper end portion, and an annular connecting structure located on the lower end portion and including a groove and a sealing flange,
wherein the nipple assembly is configured such that, when the elastomeric teat is connected to the collar such that the annular nipple flange is received inside the groove and the dome-shaped wall extends through the upper opening, and when the collar is operably connected to the first neck, the sealing flange is pinched between an upper edge of the first neck and the annular nipple flange.

4. The baby feeding system of claim 1,
wherein the first lower flange comprises a fourth cylindrical structure having a third outer diameter and having third exterior threads formed thereon and arranged in a third helical pattern, wherein the second lower flange comprises a fifth cylindrical structure having a fourth outer diameter and having fourth exterior threads formed thereon and arranged in a fourth helical pattern, the third outer diameter being equal to the fourth outer diameter and the third helical pattern being equal to the fourth helical pattern, and
wherein the bottom cap comprises:
a sixth cylindrical structure having a second inner diameter that is slightly larger than the third and fourth outer diameters and includes second interior helical threads that are configured to mate with the third and fourth exterior threads,
a cover plate connected to the sixth cylindrical structure such that that the cover plate substantially encloses the first lower opening when the bottom cap is operably connected to the first lower flange.

5. The baby feeding system of claim 4,
wherein the sixth cylindrical structure and the cover plate comprise an integrally molded plastic structure,
wherein the cover plate defines one or more vent openings, and
wherein the anti-colic vent device comprises an elastomeric membrane structure located on an inside surface of the cover plate and includes at least one one-way pressure regulating feature, and
wherein the bottom vent assembly is configured such that, when the bottom cap is operably connected to the first lower flange, a peripheral edge of the elastomeric membrane structure is pinched between a lower edge of the first lower flange and the cover plate.

6. The baby feeding system of claim 5, wherein said at least one one-way pressure regulating feature of the anti-colic vent device comprises one of a flap-type vent device and a pinhole-type vent device.

7. The baby feeding system of claim 1, wherein the multi-chamber bottle structure further comprises a mixing control mechanism implemented by the housing and the hollow ball member structure and configured to facilitate adjustment of the multi-chamber bottle between a travel configuration in which formula stored in the second chamber is separated from water stored in the third chamber and a feeding configuration in which the second chamber communicates with the third chamber such that the water and formula intermix to form milk.

8. (canceled)

9. A method for priming a travel-type bottle assembly, the travel-type bottle assembly including multi-chamber bottle structure, a nipple assembly and a bottom cap, the multi-chamber bottle structure including a hollow ball member including a spherical peripheral wall surrounding a first chamber, a neck located at an upper end of the spherical peripheral wall and surrounding an upper opening, a container body including a first cylindrical peripheral wall that surrounds a second chamber, a lower flange located at a lower end of the first cylindrical peripheral wall and surrounding a lower opening, a housing including a second cylindrical peripheral wall, a dome-like upper shoulder that defines a slot-like upper opening disposed at an upper end of the second cylindrical peripheral wall, a bottom opening disposed at a lower end of the second cylindrical peripheral wall, and interior helical threads formed on an inside surface of second cylindrical peripheral wall and configured to mate with the exterior helical threads of the container body, and an O-ring disposed in the annular O-ring groove, wherein the housing is configured to facilitate adjustment of the multi-chamber bottle structure between a travel/closed configuration in which the first chamber is separated from the second chamber by a watertight barrier and a feeding/open configuration in which the first chamber communicates with the second chamber by way of an opening, wherein the method comprises:
configuring the multi-chamber bottle structure in the travel/closed configuration by inserting the hollow ball member through the bottom opening into the housing such that the second neck extends through the slot-like upper opening, mounting the housing on the container body such that the interior helical threads are mated with the exterior helical threads and a lower portion of the hollow ball member is received within the bowl-like flange portion and contacts the dome-like upper shoulder against the O-ring, and rotating the hollow ball member such that a portion of the spherical peripheral wall is disposed over the second upper opening, thereby forming a watertight barrier between the first chamber and the second chamber; and
while maintaining the multi-chamber bottle structure in the travel/closed configuration, inserting and sealing both formula and water into the multi-chamber bottle structure such that said formula is inserted and sealed inside one of the first and second chambers and said water is inserted and sealed inside the other of the first and second chambers,
wherein sealing one of said formula and said water in the first chamber comprises operably attaching the nipple assembly to the neck, and
wherein sealing the other of said formula and said water in the second chamber comprises operably attaching the bottom cap to the lower flange.

10. The method of claim 9, wherein said inserting and sealing both the formula and the water comprises:
inserting said formula through the upper opening into the first chamber;
operably attaching the nipple assembly to the neck;
inserting the water through the lower opening into the second chamber; and
operably attaching the bottom cap to the lower flange.

11. The method of claim 9, wherein said inserting and sealing both the formula and the water comprises:
inserting the water through the lower opening into the second chamber;
operably attaching the bottom cap to the lower flange;
inserting said formula through and upper opening into the first chamber; and
operably attaching the nipple assembly to the neck.

12. The method of claim 9,
wherein the neck comprises a first cylindrical structure having exterior threads,
wherein the nipple assembly comprises a collar and an elastomeric teat, the collar including a second cylindrical structure having interior helical threads and an annular nipple flange that surrounds an upper opening, the elastomeric teat including a substantially dome-shaped wall that tapers from a relatively wide lower end portion to an upper end portion, one or more normally closed feeding ducts formed through the upper end portion, and an annular connecting structure located on the lower end portion and including a groove and a sealing flange, and
wherein sealing the formula in the first chamber comprises connecting the collar to the neck such that the interior helical threads of the collar engage with the exterior threads of the neck, and such that the sealing flange is pinched between an upper edge of the neck and annular nipple flange.

13. The method of claim 9,
wherein the lower flange comprises a third cylindrical structure having exterior threads,
wherein the bottom cap comprises a fourth cylindrical structure including interior helical threads that are configured to mate with the exterior threads, and a cover plate connected to the fourth cylindrical structure such that the cover plate substantially encloses the lower opening when the bottom cap is operably connected to the lower flange,
wherein the multi-chamber bottle structure further comprises an anti-colic vent device including an elastomeric membrane structure located on an inside surface of the cover plate and includes at least one one-way pressure regulating feature, and
wherein sealing the water in the second chamber comprises connecting the bottom cap to the lower flange such that the interior helical threads engage with the exterior threads of the lower flange, and such that when the bottom cap is operably connected to the lower flange, a peripheral edge of the elastomeric membrane structure is pinched between a lower edge of the lower flange and the cover plate.

14. (canceled)
